(19) United States
(12) Patent Application Publication
(10) Pub. No.: US 2005/0283436 A1
(43) Pub. Date: Dec. 22, 2005

(54) POINT OF SALE PURCHASE SYSTEM

(76) Inventors: Richard E. Greer, Greenville, SC (US); Thomas W. Epting, Greenville, SC (US)

Correspondence Address: SMITH FROHWEIN TEMPEL GREENLEE BLAHA, LLC, P.O. BOX 88148, ATLANTA, GA, 30356, US

(21) Appl. No.: 10/908,899

(22) Filed: May 31, 2005

Related U.S. Application Data
(63) Continuation-in-part of application No. 10/924,015, filed on Aug. 23, 2004.
(60) Provisional application No. 60/573,810, filed on May 24, 2004.
(60) Provisional application No. 60/497,087, filed on Aug. 22, 2003.

(51) Int. Cl. G06F 17/60

(52) U.S. Cl. 705/40; 705/38

(57) ABSTRACT

Credit underwriting for a financial transaction is automatically commenced and concluded by the initiative of a customer. The customer initiates the financial transaction by interfacing to a merchant application. This interface may include a point of sale terminal, a card reader, a kiosk or the like. Customer-pertinent information and financial transaction pertinent information is obtained as a result of the customer initiating the process. The customer-pertinent and financial transaction pertinent information is then processed and the credit underwriting is approved if the customer associated with the customer-pertinent information is qualified for underwriting of a transaction described by the financial transaction pertinent information. A financial agreement that can be accepted by the customer interfacing to the merchant application is then generated and, if accepted by the customer, the funding for the financial transaction is provided. The processing of the information can include examining a database that includes customer data that correlates to the customer pertinent information and regulatory information required by the state in which the merchant operates, government imposed requirements and merchant imposed requirements.

### CROSS-REFERENCE TO RELATED APPLICATIONS

This application is a continuation-in-part of U.S. patent application entitled POINT OF SALE PURCHASE SYSTEM, filed on Aug. 23, 2004 and assigned, Ser. No. 10/924,015, which claims in the benefit of the filing dates of U.S. Provisional Application for Patent No. 60/573,810, filed May 24, 2004 and U.S. Provisional Application for Patent No. 60/497,087, filed Aug. 22, 2003, each of which are incorporated herein by reference.

### BACKGROUND OF THE INVENTION

This invention relates generally to a computer method and system for creation of individualized financial instruments at the point of sale in retail locations.

Check cashing businesses have been established to advance customers funds based on postdated checks written by the customer. Typically, the customer must avail themselves to such businesses during normal business hours, and must also make their checks payable in relatively large increments, such as, perhaps, multiples of fifty dollars. Once the customer has been paid by his or her employer, the check cashing business presents the check for payment. The business extracts a fee for this service which may be cost prohibitive to some customers. Further, because the customer is provided with cash in relatively large increments, such as multiples of fifty dollars, the customer may actually be required to obtain more cash than their immediate needs require. The customer may thus be tempted to use such excess cash on non-necessities which could again contribute to a lack of funds after the customer's next payday, which, in turn, may then push the customer back towards check cashing businesses, resulting in an unfortunate financial cycle for the customer.

Another item of inconvenience is the fact that the customer must not only be present at such check cashing business during that business's hours, the customer must thereafter travel to an actual merchant's location to purchase the customer's basic needs, such as medicine, groceries, merchandise, clothing, gasoline, utilities, etc.

In the event the customer writes a bad check, then the customer will generally incur significant non-sufficient funds (NSF) fees by his or her bank, in addition to those penalty fees the customer may be required to pay to merchants and other parties to whom non-sufficient funds checks were written.

The foregoing problems are especially prevalent with those customers who have, or have had in the past, bad credit, or cannot obtain credit due to low income and/or too few assets.

Accordingly, there exists a need for a mechanism by which such a customer or other customer can purchase basic needs items, such as medicine, food, fuel, etc., from a merchant, even in those times when the customer may not have funds to pay for those items, with the understanding that the merchant will be paid back on or after the customer's receipt of his or her next paycheck.

### BRIEF SUMMARY OF THE INVENTION

Generally, the present invention provides a method and system for a merchant to extend credit to a customer by establishing an account to do so, with such account being paid off, or significantly paid down, on or after the customer's next payday, directly from the customer's bank account. The merchant, merchant's agent, financial institution, utility company, rental company, service provider, etc. (collectively referred to herein generally as the “merchant”) is provided with a system referred to herein as the “merchant system.” The merchant system is used to read or recognize a unique customer identifier device, such as a magnetically encoded or bar-coded customer card, or an integrated chip, micro-computer, etc., which uniquely identifies an account that is held by the customer. Alternately, the customer's personal identifier could be entered manually based on a personal identification number (PIN) or other identification device or means. For the sake of convenience, such customer identifier devices or means will be referred to collectively herein as “keys” or “cards.”

When a customer wishes to charge an item to the account, such as, perhaps, when the customer is low on funds, the customer presents the card to the merchant system, and the merchant system, after reading such information from the card, sends such information to a server system with a request that the server system access databases containing information about the customer, such as the customer's name, social security, payment plan, pay dates, credit limit, amount of credit available, current amount owed, and other information databases that may be required and/or used by the merchant or required by government regulations. The server system uses the customer information to issue an approval, or disapproval, as the case may be, back to the merchant system regarding the merchant's transaction with the customer.

If the purchase, i.e., the transaction, is approved, the server system also calculates and transmits to the merchant system applicable required federal and state “Truth in Lending” disclosure information including, finance charges, amount financed, transaction fee, total payments, payment schedule, and the annual percentage rate (APR) of interest, if necessary. If addition, the server system can also calculate a variable annual percentage rate (APR) based on the date of the transaction and the date of payment.

The server system further determines the payment schedule for the customer, to which the customer would have already agreed via a contract earlier entered into between the customer and the merchant and incorporated as a part of the new credit sale. This contract would address and disclose transaction fees imposed by the merchant on the customer on a per transaction basis. It is to be understood, however, that instead of, or in addition to, the transaction fee, any interest charge could be imposed on the customer by the merchant based on the amount of the transaction. The server system determines the actual calendar dates on which payment is to be made by the customer, and the actual payment method, such as by electronic funds transfer (EFT), automated check clearinghouse (ACH), cash, check, at the merchant's location, or by other means.

Briefly, the server system converts and formats a transaction document, i.e., financial instrument, which is ultimately printed by the merchant system. Using the information discussed above, such financial instrument is created, printed out, and ultimately signed by the customer at the point of sale (POS).

The server system communicates with the merchant system to generate the financial instrument, which, in one preferred embodiment, is printed at the actual merchant point of sale, which, for example, could be the checkout stand where the transaction is being made. Such financial instrument could actually be printed by the same printer used to print merchandise receipts, or, could be printed out at an auxiliary printer, such as may be used to print coupons at checkout stations, automated and/or self-checkout configurations, or at prepaid phone card terminals, etc.

Through cooperation of the merchant system and the server system, the financial instruments created are purchase transaction-initiated and are stand-alone documents ready for the customer's signature at the point of sale for the amount of transaction, together with any transaction fees. Such financial instrument can be configured to be in compliance with applicable federal, state and local requirements for such transactions.

It is noted that the merchant system and the server system could be co-located on the same premises, or could be separated, with communications between the merchant system and server system being handled by ordinary telecommunication lines, the world wide web (WWW), global or semi-global wide area networks, cellular telecommunications systems, satellite telecommunications systems, radio frequency systems, infrared systems, microwave systems, optical systems, or other systems suitable for conveyance of information.

The present invention also includes the server system being configured to produce and deliver a statement to the customer for each transaction in an open-end or revolving credit arrangement, depending on the particular circumstances, the particular consumer, limited time credit incentives offered by the merchant, location of the merchant, types of goods or services offered by the merchant, etc.

The present invention contemplates a further alternate embodiment including using the server system equipment for both merchant credit sales and for providing a cash loan to a customer, using the same or a modified database.

Additionally, the present invention includes the use of a customer's check, and the presentation by the customer of the check in order to form a credit agreement. Using only a check written or otherwise presented to a merchant, the merchant can create a closed-end merchant consumer credit sale generally in compliance with applicable federal, state, and local law and regulations.

In one embodiment of the invention, credit underwriting for a financial transaction is automatically commenced and concluded by the initiative of a customer. The customer initiates the financial transaction by interfacing to a merchant application. This interface may include a point of sale terminal, a card reader, a kiosk or the like. Customer-pertinent information and financial transaction pertinent information is obtained as a result of the customer initiating the process. The customer-pertinent and financial transaction pertinent information is then processed and the credit underwriting is approved if the customer associated with the customer-pertinent information is qualified for underwriting of a transaction described by the financial transaction pertinent information. A financial agreement that can be accepted by the customer interfacing to the merchant application is then generated and, if accepted by the customer, the funding for the financial transaction is provided. The processing of the information can include examining a database that includes customer data that correlates to the customer pertinent information and regulatory information required by the state in which the merchant operates, government imposed requirements and merchant imposed requirements.

### BRIEF DESCRIPTION OF THE SEVERAL VIEWS OF THE DRAWING

The foregoing, as well as other objects of the present invention, will be further apparent from the following detailed description of the preferred embodiment of the invention, when taken together with the accompanying specification and the drawings, in which:

FIG. 1 is a block diagram illustrating an embodiment of the present invention;

FIGS. 2A and 2B are flow diagrams of a routine for generating unique purchase decision initiated financial instruments for a point of sale purchase system constructed in accordance with the present invention;

FIG. 3 is a sample agreement between a customer and a merchant contemplated by the present invention; and

FIG. 4 is an example of a unique financial instrument generated pursuant to implementation of the present invention.

### DETAILED DESCRIPTION OF THE INVENTION

The accompanying drawings and the description which follows set forth this invention in its preferred embodiment. However, it is contemplated that persons generally familiar with financial and credit information and transactions will be able to apply the novel characteristics of the structures illustrated and described herein in other contexts by modification of certain details. Accordingly, the drawings and description are not to be taken as restrictive on the scope of this invention, but are to be understood as broad and general teachings.

Referring now to the drawings in detail, wherein like reference characters represent like elements or features throughout the various views, the point of sale purchase system of the present invention is indicated generally in the figures by reference character 10.

The present invention provides a method and system for creation of unique purchase decision initiated financial instruments for point of sale transactions, which could be in the wholesale, retail, e-commerce, business-to-business, etc. arenas, and includes a combination of computer hardware and software for allowing the creation of new, individualized financial instruments, including loan documents, at the point of sale. These financial instruments may be used for the amount of the transaction or for a combination of transactions, or for establishment of new accounts and for issuing instant credit. The financial instruments often will be between a customer and a merchant or his or its agent, which can include banks, other financial institutions, or the like.

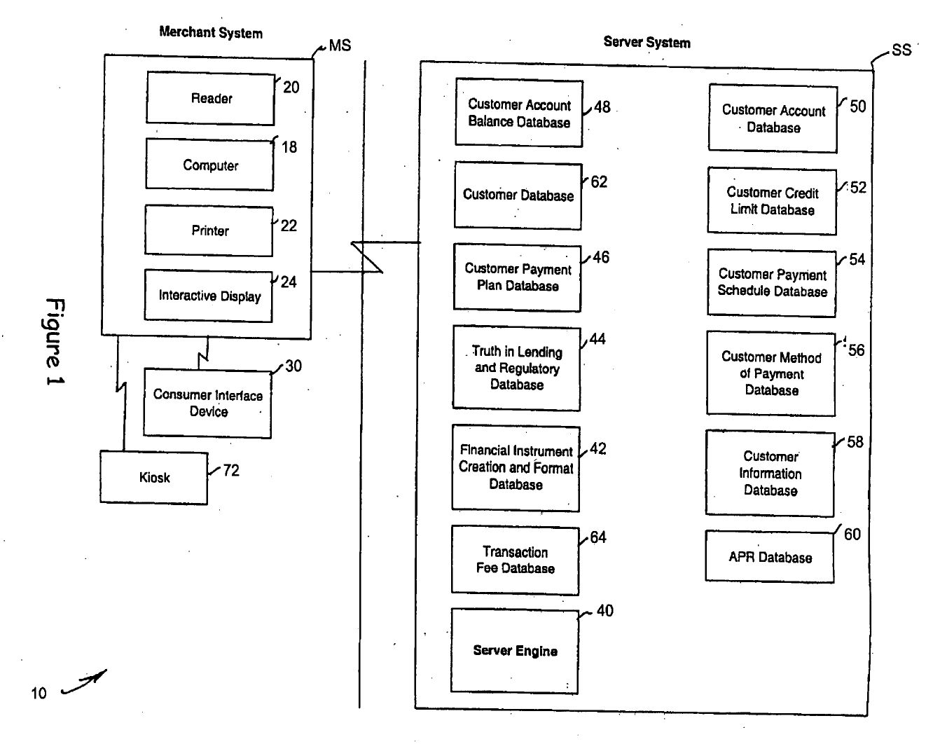

FIG. 1 is a block diagram illustrating an embodiment of the present invention. This embodiment supports a point of sale purchase transaction system including a merchant system and a server system. The merchant system, generally MS, is preferably computer-based, and also includes a reader 20, a printer 22, and/or an interactive display 24 interfaced with the computer 18. The reader 20 is used to read a customer interface device, such as a card, which can be encoded with magnetic, barcode, optical, etc. encoding, or could be a chip or microcomputer capable of storing identifying information about the customer. It is to be understood, however, that the customer interface device, or, referred to herein generally as a key, or, card 30, could be of various configurations, and, could be bypassed altogether by the customer, with the customer simply entering a personal identification number (PIN) together with a user ID, or through use of some other identification means, such as a driver's license, together with an identification number.

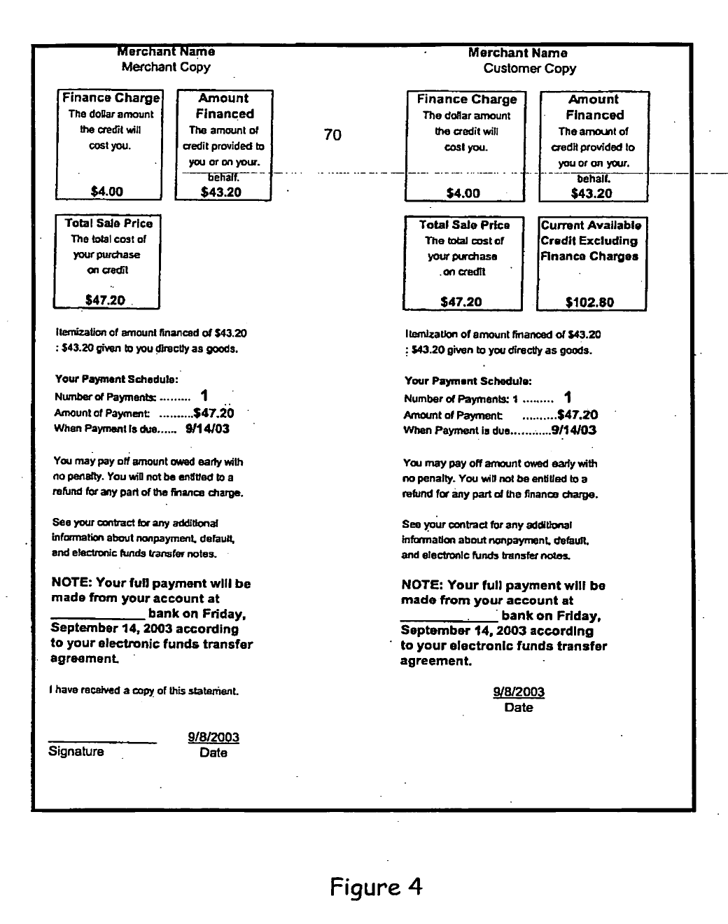

The reader 20 is preferably connected to the computer 18 and transmits information to the server system, generally SS. The printer 22 or interactive display 24, which are preferably connected to computer 18, could, instead, be connected directly to the server system SS, if desired, and serve to printout and/or display uniquely tailored financial instruments, an example of which is shown in FIG. 4, both for the merchant, and for the customer. It is to be understood that the financial instruments illustrated in FIG. 4 are representative only, and that the present invention is not limited to such examples. The financial instruments could take on a variety of different configurations, appearances, and styles, without departing from the teachings of the disclosure.

Merchant system MS and server system SS could be co-located on the same premises, or could be separated altogether in different locations. Communication is enabled between merchant system MS and server system SS, such as through the use of conventional telecommunications systems, local area networks, wide area networks, point-to pint dial-up connections, or through radio frequency systems, microwave systems, infrared systems, optical systems, satellite systems, the World Wide Web (WWW), etc. Merchant system MS and server system SS may each comprise any combination of hardware or software that allow interaction between the merchant system MS and the server system SS, and such software and hardware will be apparent to one of ordinary skill in the art.

Server system SS includes a server engine 40, a financial instrument creation and format database 42, a Truth In Lending and regulatory database 44, a customer payment plan database 46, a customer account balance database 48, a customer account database 50, a customer credit limit database 52, a customer payment schedule database 54, a customer method of payment database 56, a customer information database 58, having the customer's personal information, such as the customer's name, address, employer name, social security, and personal information, an annual percentage rate (APR) database 60, a customer database 62, and a transaction fee database 64. It should be understood that the term database may be applied to separate data bases created through programs such as MICROSOFT ACCESS or other similar products, or through proprietary programs or simply as indexed flat files. Thus, the databases may be physical databases or logical databases.

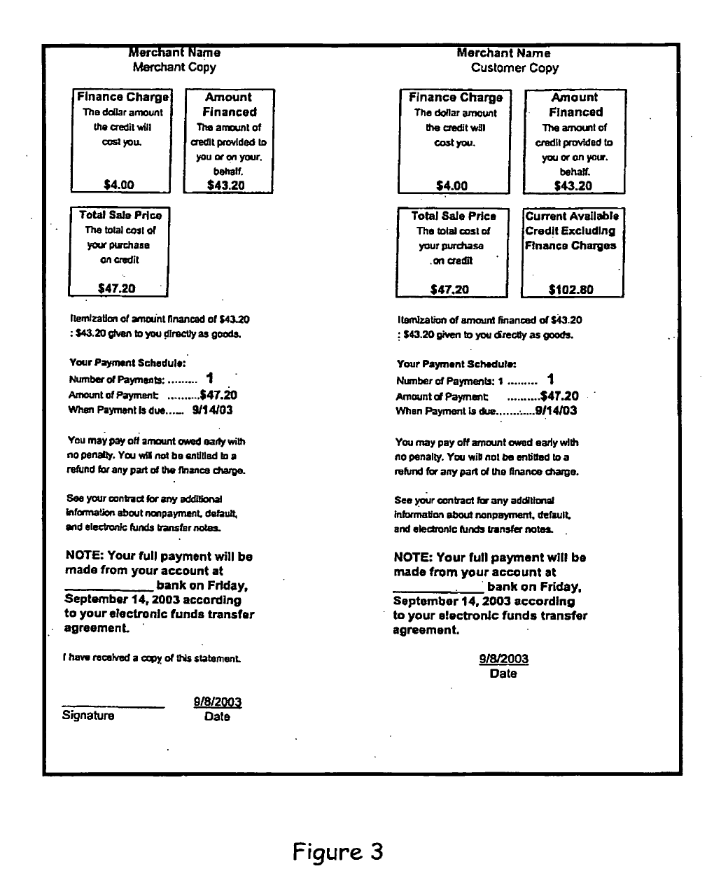

The server engine 40 receives requests from the merchant system MS and provides responses back to the merchant system MS. Requests from the merchant system MS would indicate that the customer is requesting a credit sale. The customer database 62 contains customer information for various customers who have entered into an agreement with the merchant. An example agreement between a customer and a merchant is illustrated in FIG. 3, although it is to be understood that such agreement is illustrated for example purposes only, and that the agreement could be made between the customer and the merchant in a variety of different ways without departing from the teachings of this disclosure. For example, they could be simplified or made more elaborate in printed form, or could be provided to the customer in electronic form via email or at the point of sale, with the customer's signature being captured electronically and stored electronically.

The customer method of payment database 56 contains information regarding the customer's agreed upon methods of payment, be it electronic funds transfer (EFT), automated check clearinghouse (ACH), payment by cash, check, debit card, credit card, or some other means.

The customer payment schedule database 54 includes information regarding the date on which the customer normally receives his or her paycheck. The customer credit limit database 52 contains information regarding the credit limit which has been assigned to a particular customer, and the customer account balance database 48 contains information on the customer's then-current balance owed (or owed to the customer by the merchant, in the event the customer has a credit balance). The customer account database 50 contains information regarding the customer's account number, account status, such as active, inactive, closed, etc. The Truth in Lending and regulatory database 44 contains information regarding applicable truth in lending federal, state and local disclosure information regarding finance charges, amount financed, total payments, payment schedule, and annual percentage rate. This database may also include other information required by individual jurisdictions for completion of financial documents and miscellaneous information which may be required by the merchant or government regulatory body. The transaction fee database 64 provides the appropriate transaction fee to be charged for the particular transaction.

The financial instrument creation and format database 42 contains information regarding the creation of financial instruments for execution by the customer in a point of sale transaction, and also for formatting the financial instrument 70 (FIG. 4) for printing out on a printer 22 for execution by the customer. Alternately, the financial instrument 70 could be presented in a graphical or digital form, which the customer would execute by signing a touch screen-type display. This could find particular use in automated and/or self-checkout stations used by some merchants. The format of the actual financial instrument format may be held in template form, physically or electronically, in the merchant system MS, server system SS, or terminal, or held in the printer 22 or display 24.

In another alternate embodiment, the customer could elect to simply have the financial instrument forwarded to a specified email address for receipt by the customer at that address. The server system SS could, using the server engine 40, also, if desired, transmit reminder emails to the customer reminding the customer that on a date certain, the customer's account will be debited in order to payoff all or a portion of the customer's balance of the account with the merchant.

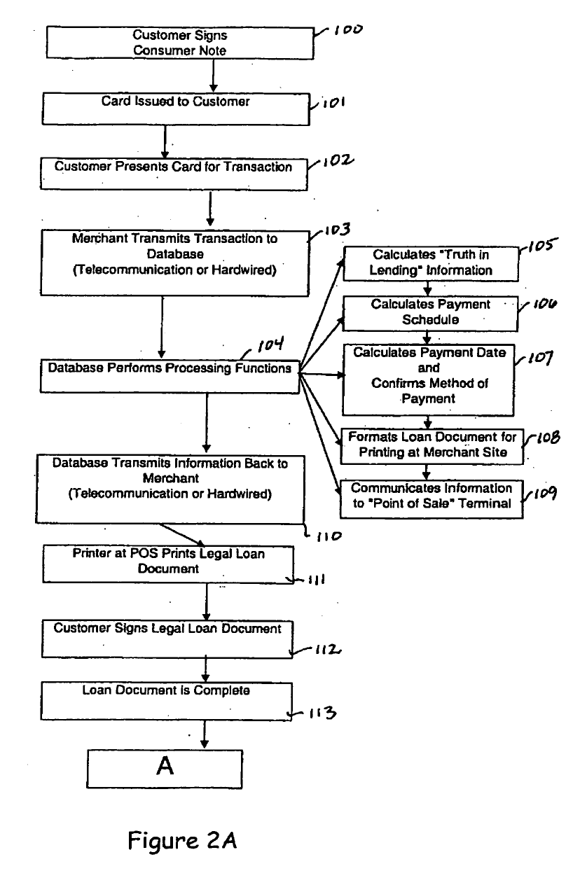

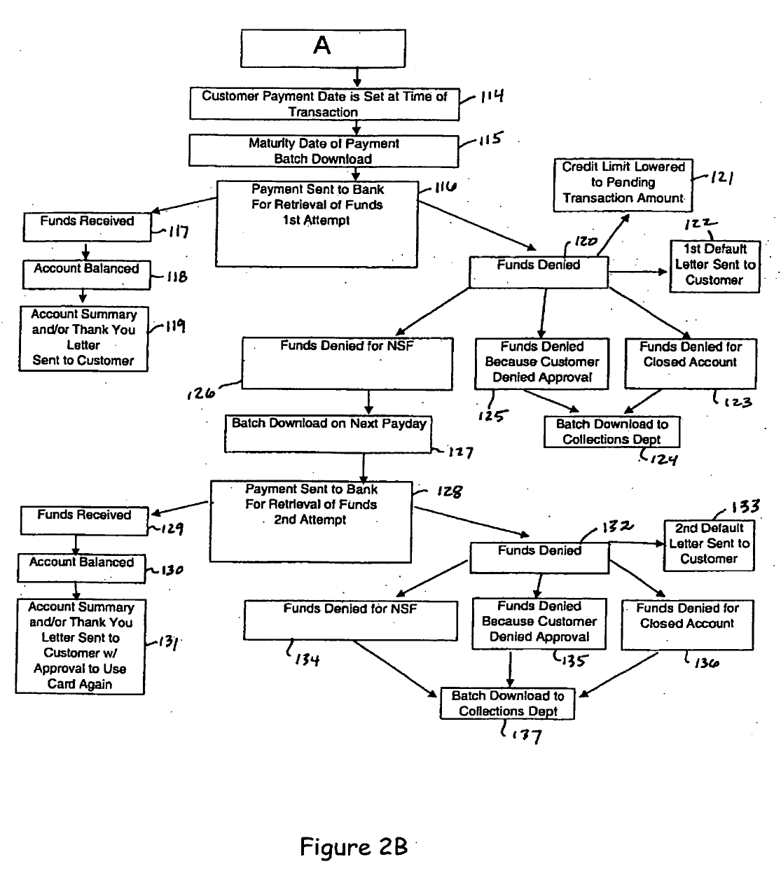

FIGS. 2A and 2B illustrate a flow diagram of a routine for creating point of sale financial instruments in accordance with the present invention. At the outset, to enable the server system SS to be operational for particular customer, the basic information will need to be inputted into the server system SS pertaining to the customer. This information can be keyed in by an operator, based on the information provided to the merchant, or its designee, by the customer on an agreement, such as illustrated in FIG. 3, or could be inputted into a computer directly by the customer at a website provided by the merchant, through use of the world wide web.

Alternately, a merchant could provide a kiosk 72, or other data entry point, on-site for use by the customer to complete an application for a merchant credit account with the particular merchant.

In step 100, the customer provides the information and agrees to the terms of the merchant agreement. In response, the merchant, in step 101, issues a card or other customer identifier device to the customer. In step 102, the customer presents the card or other device for a transaction with the merchant. The merchant transmits the transaction, in step 103, to the server system SS, and steps 104, 105, 106, 107, 108 and 109 involve use of software to process the information drawn from the databases 42, 44, 46, 48, 50, 52, 54, 56, 58, 60, and 62 of the server system SS. The server system SS, after processing such information, forwards a response back to the merchant server MS in step 110 indicating whether the transaction is approved or disapproved. If the transaction is approved, then printer 22 or other display device 24 is used to generate a financial instrument 70 at step 111 for execution by the customer, which takes place at step 112. Thus, at step 113, the financial instrument is complete. Accordingly, the merchant system MS and the server system SS complete a legally binding stand-alone credit instrument initiated by the customer, with the only input having been the customer's identifier and the transaction amount.

On the financial instrument, the customer is provided with a payment date, which is calculated at the time of the transaction, as shown in step 114.

It is to be understood that in those situations where the server system SS is co-located on the premises with the merchant system MS, it may be desirable to, instead of having a communication link established between the server system SS of a number of merchant locations with a central server system, which continuously monitors the customer's use of his or her account, instead, an in-store server system (having both the merchant system MS and server system SS on the same premises) could download the information it receives during a day's transactions to a central, off-site server, and could also receive information updating the customer's account. Thus, if the customer had made multiple credit transactions at various ones of the merchant's stores, this information could be tabulated and accounted for at the end of the day by a server system SS which is located off-site.

Turning to FIG. 2B, in step 115, the maturity date of the payment is batched downloaded and sent (step 116) to the customer's bank for retrieval of funds, in the case of electronic funds transfer (EFT) and automated check clearinghouse (ACH) transactions. If funds are received, then steps 117, 118, and 119 are pursued.

If funds are declined, as shown in step 120, then step 121 occurs to lower the credit limit of the customer's account, and a first default letter is sent to the customer in step 122. If the funds are denied due to a closed account 123, then such information is downloaded and sent for collections purposes (step 124), as indicated in step 123. Similarly, if funds are denied because a customer is denied approval (step 125), then such information would be transferred for collections 124.

If the funds were denied for non-sufficient funds (NSF), as shown in step 126, then on the customer's next payday or other pre-selected date (step 127), a second attempt will be made for retrieval of the funds, as shown in step 128. If funds are available, then steps 239, 130, and 131 are followed, with the customer's account being balanced.

If funds are again denied (step 132), then a second default letter is sent to the customer (step 133), and if the funds are denied for non-sufficient funds (step 134), because the customer is denied approval (step 135), or because the customer's account was closed (step 136), then such information is transferred for collections (step 137).

From the foregoing, it can be seen that a merchant, or its designee, and a customer completes an application or customer note, such as shown in FIG. 3 for credit. The customer then indicates a payment mechanism to be used. Such payment mechanism can include by way of non-limiting example, payment by check, by cash, or by electronic funds transfer (EFT) or automated check clearinghouse (ACH). After completing the application, the customer, as an incentive, may be given an instant credit good for an agreed amount of credit for merchandise.

At the point of sale, the customer executes a financial instrument, such as a credit or loan agreement, which has been generated by the merchant system MS and server system SS. The financial instrument is preferably in compliance with applicable laws and regulations, and its generation is begun as follows:

a. The customer presents his customer identifier device, which may be a card, which has been issued by the merchant or the merchant's designee. The device has the customer's name and account number and other information stored on a magnetic strip, bar code, imbedded chip, computer, etc. The merchant at the point of sale ascertains the information by, in the case of a card, swiping the card over a reader, or simply by manual input of the card number, customer's name, or other identifying method.

b. The merchant uses a merchant system MS to transmit information concerning the customer and the amount of the transaction to the server system SS, which may be located at the merchant's location, or at an off-site location. The databases within the server system SS include the following information:
i. name of customer;
ii. social security number of customer;
iii. payment plan for customer;
iv. the date the payment plan indicates payment will be made;
v. credit limit for the customer;
vi. amount of credit available;
vii. current amount owed by customer;
viii. other information required by individual states or jurisdictions for completion of financial documents; and
ix. miscellaneous information that may be required by the merchant or a government regulatory body.

c. The server engine is programmed with software that takes the information from the point of sale at the merchant's location and performs the following functions:
i. determines and calculates necessary federal and state “truth in lending” disclosure information including finance charges, amount financed, transaction fee, total payments, payment schedule, and an annual percentage rate of interest, if necessary. The software can, if necessary, calculate variable annual percentage rates, based on the date of the transaction and the date of payment, which may vary from financial instrument to financial instrument, and transaction to transaction;
ii. determines the payment schedule for the payment plan agreed to in the contract;
iii. determines the actual date or dates of payments to be made by the customer and the method of payment;
iv. formats the financial instrument using the information computed above for signature by the customer at the point of sale; and
v. communicates with the point of sale terminal (which may be a separate terminal for these transactions or any printer capable of printing the contract, or display capable of displaying an electronic form of the contract, or the cash register, prepaid phone card terminals, or other terminals or stations).

d. The result of the foregoing is thus a legal, stand-alone financial instrument, one possible example being shown in FIG. 4 (ready for the customer signature at the point of sale, for the amount of the transaction, or combination of transactions). In the alternative, a customer may be granted instant credit, before even having his or her application.

A unique feature of the present invention is that the system is initiated by the customer. The customer, using his or her customer identifier device, such as a card, key, PIN number, etc. presents such at the point of sale, which initiates the process which ultimately results in the generation of uniquely tailored financial instruments. These financial instruments are developed, as discussed above, through accessing of data from specified databases, within a server system, and by manipulation of such data.

While the present invention has been discussed in terms of a customer and merchant relationship, it is to be understood that the present invention could be easily adapted and used between businesses, in a so-called “B to B” relationships. It is to be further understood that the present invention contemplates production of financial instruments which could be either negotiable or non-negotiable instruments. While the financial instruments discussed here have been referred to in certain instances as loans or credit documents, they could also be advances, deferred payment documents, layaway documents, etc.

The present invention calculates, formats, and prints out Truth in Lending information and the appropriate transaction fee at the point of sale and, in one preferred embodiment, provides a date certain in which payment will be drafted from the customer's account through an electronic funds transfer.

Accordingly, the present invention involves a method of making a point of sale transaction comprising:

a. under control of a merchant system, in response to a customer providing customer identifying information, sending a request to authorize the customer's purchase of an item, along with an identifier of the purchaser of the item to a server system;

b. under control of an authorization component of the server system, receiving the request, sending an inquiry to an account verification facility having stored information relating to the customer, generating an authorization to purchase the requested item for the customer identified by the customer identifier information in the received request and upon receiving a purchase authorization from the account verification facility, generating a financial instrument and applying a transaction fee in order to complete the purchase of the item, whereby the financial instrument includes substantially complete Truth in Lending information for the transaction and a date certain in which full payment will be made by the customer; and

c. under control of the account verification facility, upon receipt of the inquiry from the server, querying the stored additional information relating to the customer identified by the customer identifier information in the request, and sending to the merchant system a credit authorization.

The present invention also includes a system for processing orders, comprising:

a. a merchant terminal having a user interface that is interactive to communicate with entities via the internet, the merchant terminal having an input device capable of sending an indication of the amount of an item being purchased, together with an identifier of the customer, upon presentation by the customer of identifier information unique to the customer;

b. a server configured for receiving the purchase information and customer identifier information from the merchant terminal, receiving additional information previously stored for the customer identified by the customer identifier information in the received request; and generating an authorization allowing purchase of the requested item for the customer identified by the customer identifier information in the received request using the retrieved additional information; and an account verification facility for receiving the account verification data, comparing the account verification data with stored account data corresponding to the customer, and generating a transaction approval; and

c. the server being further configured to receive the transaction approval generated by the account verification and for applying a transaction fee and for generating financial instruments containing substantially complete Truth in Lending information regarding the transaction and a date certain in which full payment will be made by the customer.

The present invention also includes the server system SS being configurable to produce and deliver a statement to the customer for each transaction in an open-end or revolving credit arrangement. Each statement generated by either printer 22 or on a consumer interface device 30, which as noted above, could be a stand-alone device, a device located at or apart from the point of sale, a kiosk 72, and could be either unattended, or attended by an attendant. The statement generated would meet the qualification of open and revolving credit requirements, including all federal, state, and other regulatory or contractual requirements or by custom.

Such requirements may include a listing of all transactions to be paid for on a specified or predetermined due date; determination of such due date through use of the server system SS (such due date may be based on the customer's payday cycle); the providing of information to the customer regarding how to dispute or ask questions concerning amounts or other information on the statements; an indication of credit used and credit remaining available to the consumer; and a calculation of the annual percentage rate (APR) and other information and data required by law, regulation, contract, custom, etc.

All of the above information regarding this embodiment of the present invention can be provided to the consumer at or remote from a point of sale, with or without an attendant, or at a standalone kiosk 72, drive-through, automatic teller machine (ATM), or some other location, and allows for an electronic funds transfer (EFT) payment to be made within a specified time, for example, ten days from the date of the transaction. This embodiment of the present invention includes server system SS having the database discussed above being configured to provide information for the printing and/or display of an up-to-date statement of account to the consumer when a request is made of the server system SS and/or at the time credit is advanced on an open or revolving credit account. This type of statement would differ in the respects indicated above from the consumer credit sale contract earlier discussed, since the open-end/revolving credit arrangement more closely matches typical consumer charge accounts, credit card accounts, bank lines of credit, equity line accounts, etc.

In one embodiment of this open-end/revolving credit arrangement, a store could take an ID card, driver's license, military identification, PIN number, and/or other identifier of a consumer having such an open-end/revolving credit account, and deliver cash to the consumer after processing the consumer's loan request through a terminal, such as computer 28. Again, however, it should be noted that the entire transaction could be performed without an attendant, with the consumer using a self-serve terminal, which could be a kiosk 72, ATM, or other standalone device which may or may not have an attendant. The transaction could be performed wherein the consumer receives a printed statement at the time credit is obtained from his or her open-end/revolving credit account, or, alternately, the system could be paperless, and instead provide the consumer with a statement which is emailed to an email account designated by the consumer or simply displayed on the screen, with the consumer choosing not to receive a printed statement.

The present invention contemplates a further alternate embodiment including using the server system equipment for both merchant credit sales and for providing a cash loan to a customer, using the same or a modified database. In such an arrangement, a customer could approach an automated checkout stand, a checkout stand attended by an attendant, an ATM, a kiosk 72, etc., and enter an icon on a display screen, or take some other action, such as entering a PIN, swiping an identification card, driver's license, smart card, or other similar device, and indicate he or she wishes to take out a loan. Such server system equipment would query the amount of money requested by the customer and would process such a loan in a manner as discussed above on a closed end credit arrangement or an open-end/revolving credit arrangement. The printer 22 can be used to print a completed loan document ready for the customer's signature, or, as discussed above, alternately, the customer may sign a keypad having their signature recorded electronically. The customer could elect whether to receive or not receive a printed statement. If a printed statement is delivered and signed by the consumer, then the consumer would either deposit the statement in a specified location with respect to the equipment, or, if the station is attended, provide the signed copy of the loan document to the attendant. After confirmation that the consumer has provided a signature, either electronically or on paper, the cash requested by the consumer would be provided, to the extent that provision of such cash could not exceed the consumer's available credit.

Another alternate embodiment of the present invention could be a modification of the merchant system (MS) and server system (SS) discussed above such that a signature-based electronic check (E-check) could be used. In this embodiment, the server system SS would be configured to immediately poll the user's bank account on which the E-check is drawn, and if the funds are available, immediately removes such funds specified in the E-check from the account. In the event the funds specified in the E-check are not available, to the extent there is a deficiency, the server system SS would generate either a closed end loan document, which would be deducted from the consumer's account after the consumer's next payday, or other specified date, or, alternately, generate a loan from an open-end/revolving credit loan account which had already been put in place by the consumer, and generate the necessary statement, as discussed above, for the consumer.

Furthermore, it should be understood that the systems of the present invention could be configured to accept as suitable identification a user's personal check for ID purposes. If the user/consumer had already established a merchant credit and/or open-end/revolving credit account, such account would already be tied to the consumer's bank account reflected on the check, the consumer would then only need to provide, perhaps, a PIN, driver's license, military ID, or other suitable identification.

It is to be further understood that the open-end/revolving credit arrangements discussed above could work either separately, or in conjunction with the merchant credit system in order to automatically debit a consumer's account to EFT or ACH upon the user's next payday, or at some other predetermined date.

A still further version of the present invention includes the use of a customer's check, and the presentation by the customer of the check in order to form a credit agreement. Using only a check written or otherwise presented to a merchant, the merchant can create a closed-end merchant consumer credit sale that is in compliance with applicable federal, state, and local law and regulations.

To illustrate this version of the present invention, the customer chooses the merchant's goods or services the customer wishes to purchase. When asked for payment, the customer selects an option on a keypad, touch screen, or interface which may be identified as “Bill Me Later,” or by some other suitable designation. Alternately, the customer simply informs the merchant that they would like the transaction to be a credit one. A blank check from the customer's financial institution's account is scanned, and using the information printed on the check itself, the customer's information associated with such account (such as name, address, phone number, financial institution account number, etc.) is received and used by the server system SS to generate a consumer credit note which is printed at the register, kiosk, self-serve check-out, point of sale location, or some other location. Alternately, such consumer credit note could be mailed or emailed to the customer if desired. This consumer credit note would preferably include the name of the customer, the terms of the note, the Truth in Lending information and the method of payment. The information necessary to form the consumer credit note is thus generally available and derived from scanning the customer's check. If desired, the customer could also be required to enter his or her PIN at the time of the transaction, for added security.

A third party may administer this version of the present invention using the customer's financial institution account number and databases discussed above in regards to generation of the actual loan or credit documents. The initial presentation of the check would be the functional equivalent of the application process discussed above, with the exception that in such a version of the present invention, a check is given instead of requiring the prior execution of a credit agreement. It should also be appreciated that the presentation of the check could be in addition to a credit agreement. In such an embodiment, the check could be signed or otherwise executed by the consumer (for example, through use of a password and PIN, etc.). In this version of the present invention, a third party would be able to track and manage the credit given or offered to the customer based on the customer's financial institution account information alone. The financial institution could, if desired, actually image the check and maintain such image of the check for information and potential collection action purposes. The third party could also charge the customer a fee for generating the credit documents, which would be added to the amount of the customer's transaction. Alternately, the merchant may absorb the cost of any such third party fees as an accommodation to the customer.

In its simplest form, this version of the present invention would not require the customer to have at some earlier time signed or executed a credit application. The credit would be given to the customer solely based on the customer's check, and if the check would normally be accepted under typical check acceptance rules or guidelines, then the credit agreement would be generated simply by the customer's presentation of the check. This system could be potentially attractive to a merchant for a customer who does not regularly shop at that particular merchant, such customer being less likely, perhaps, to sign up for the merchant's formal, credit program. The merchant would thus be able to extend credit to the customer, based on the acceptance of the customer's check, with the databases discussed above being used to generate the Truth in Lending information and other information and also to generate the necessary credit documents for printing, mailing, emailing, etc. to the customer. In these cases, the merchant would potentially reduce the overhead associated with such a one-time or infrequent customer by simply accepting the check as a basis for extending credit, rather that generating, processing, and retaining a separate agreement, issuing the customer a card, etc.

As to the payment of such credit extended under this version of the present invention, the merchant would provide for a specified time period after which the merchant would debit (through ACH, EFT, etc.) the customer's financial institution account. This time period can be a matter of days, weeks, months, etc., depending on the merchant, customer, goods or services purchased, value of the credit, or other factors. A set fee could be charged by the merchant for the transaction, and the amount of such fee could be based on the amount of credit extended and/or the length of time which the merchant waits before debiting the customer's account. As noted above, in addition to the consumer being required to present a check, the merchant could also require other forms of personal identification, such as a driver's license, PIN, or other means of identification.

While preferred embodiments of the invention have been described using specific terms, such description is for present illustrative purposes only, and it is to be understood that changes and variations to such embodiments, including but not limited to the substitution of equivalent features or parts, and the reversal of various features thereof, may be practiced by those of ordinary skill in the art without departing from the spirit or scope of the present disclosure.

1. A method for automatically approving credit underwriting for a financial transaction based on the initiation of the financial transaction by a customer, the method comprising:
initiating a financial transaction by interfacing to a merchant application;
obtaining customer-pertinent information and financial transaction pertinent information;
processing the customer-pertinent and financial transaction pertinent information and approving the credit underwriting if the customer associated with the customer-pertinent information is qualified for underwriting of a transaction described by the financial transaction pertinent information;
providing a financial agreement that can be accepted by the customer interfacing to the merchant application; and
funding the financial transaction if the financial agreement is accepted by the customer.

2. The method of claim 1, wherein the step of initiating a financial transaction comprises initiating a purchase at a point of sale terminal that interfaces to the merchant application.

3. The method of claim 1, wherein the step of initiating a financial transaction comprises sliding a magnetic card through a magnetic card reader that interfaces to the merchant application.

4. The method of claim 1, wherein the step of initiating a financial transaction comprises initiating a purchase and providing identification criteria.

5. The method of claim 5 wherein the identification criteria includes a customer identification number and a personal identification number.

6. The method of claim 1, wherein the step of processing the customer-pertinent information and financial transaction pertinent information comprises examining a database that includes customer data that correlates to the customer pertinent information and regulatory information required by the state in which the merchant operates, government imposed requirements and merchant imposed requirements.

7. The method of claim 6, wherein the step of processing further comprises determining if the customers credit limit is sufficient for the value of the financial transaction.

8. The method of claim 1, wherein the step of providing the financial agreement comprises printing out a copy of the financial agreement, the financial agreement including federal compliant financing information including a payment schedule.

9. The method of claim 1, wherein the step of providing the financial agreement comprises displaying the agreement on a display device, the displayed financial agreement including federal compliant financing information including a payment schedule, interest charges, and fees.

10. The method of claim 1, wherein the step of funding the financial transaction comprises granting a credit to the customer.

11. The method of claim 1, wherein the step of funding the financial transaction comprises granting a credit to a financial account of the customer.

12. A method of financing a transaction for a customer at a merchant location, the method comprising the steps of:
a customer initiating a financial transaction at a merchant location;
the customer providing customer-pertinent information to a merchant application;
the merchant application providing at least a portion of the customer-pertinent information and a transaction value to a server application;
the server application determining federal compliant financing information related to financing the transaction;
the server application incorporating the federal compliant financing information into a financial instrument;
the server application providing the financial instrument to the merchant application; and
the merchant application presenting the financial instrument to the customer for execution;
the merchant application receiving an acceptance of the financial instrument by the customer;
the merchant application approving the transaction.

13. The method of claim 12, wherein the step of the server application determining the federal compliant information related to the financing transaction further comprises the steps of:
calculating the finance charges;
identifying the amount financed;
calculating a transaction fee;
calculating the number of payments;
calculating a payment schedule; and
determining an annual percentage rate of interest.

14. The method of claim 13, further comprising the steps of:
at a payment due date identified in the payment schedule, sending a payment request to a bank managing an account associated with the customer;
if the funds are received, sending notification to the customer;
if the funds are denied, sending a default notice to the customer, adjusting the customer credit limit, and
if the funds were denied for insufficient funds, scheduling another payment request at a future date and
if the funds were denied due other reasons, enlisting a collections process.

15. The method of claim 14, wherein if the funds were denied for insufficient funds, at the future date sending another payment request to the bank managing the account associated with the customer and,
if the funds are received, sending notification to the customer;
if the funds are denied, sending a second default notice to the customer and enlisting a collections process.

16. A system for credit underwriting of financial transactions initiated by a customer at a merchant location, the system comprising:
a merchant application;
a server application communicatively coupled to the merchant application;
the merchant application interfacing to a point of sale terminal and an input device, the merchant application being operable to receive customer pertinent information through the input device and financial transaction pertinent information through the point of sale terminal and provide the information to the server application;
the server application including an interface to truth in lending and regulatory database, a financial instrument creation and format database, a customer information database, and an annual percentage database, the server application being operative to access these databases to generate a financial instrument and provide the financial instrument to the merchant application;
the merchant application further interfacing to an output device and being operative to provide the financial instrument to the output device.

17. The system of claim 16, wherein the input device comprises a magnetic card reader and the system of operative to initiate the credit underwriting by detecting a customer sliding a magnetic card through the magnetic card reader.

18. The system of claim 16, wherein the customer information database further comprises:
a customer account balance database;
a customer payment plan database;
a customer account database;
a customer credit limit database;
a customer payment schedule database; and
a customer method of payment database.

19. The system of claim 18, wherein the server application is further operative to generate a financial instrument by including payment terms.

20. The system of claim 18, wherein the server application is further operative to generate a financial instrument that identifies a payment schedule, an annual percentage rate, and payment amounts.
